(19) United States
(12) Patent Application Publication
(10) Pub. No.: US 2021/0108663 A1
(43) Pub. Date: Apr. 15, 2021

(54) Multi-Fastener Supply Depletion Indicator

(71) Applicants: Jonathon J. THOMPSON, Gold Beach, OR (US); Daniel R. CLARK, Gold Beach, OR (US)

(72) Inventors: Jonathon J. THOMPSON, Gold Beach, OR (US); Daniel R. CLARK, Gold Beach, OR (US)

(73) Assignee: Thompson Handyman Services LLC, Gold Beach, OR (US)

(21) Appl. No.: 16/600,116

(22) Filed: Oct. 11, 2019

(51) Int. Cl. F16B 15/08

(52) U.S. Cl. CPC F16B 15/08; B25C 1/003

(57) ABSTRACT

Coil nails and similar fasteners to be driven by an automatic nailing tool have at least two different visual appearances after driving. Fasteners driven from a fresh magazine have a first visual appearance, and fasteners driven thereafter from the same magazine have a second, different visual appearance. A magazine may include fasteners having three or more different appearances. Preferably, all of the different appearances are grouped together so that all of the first appearance fasteners are driven, then all of the second appearance fasteners, and so on, until the last fastener having the last appearance is driven. Visual differences may be in color, size, shape, surface texture, or another characteristic.

### FIELD

The invention relates to nails and similar fasteners formed in integral series but easily separable. More specifically, the invention relates to attributes of belts of nails suitable for dispensing through a nail-feeding device that improves the overall workflow for the user.

### BACKGROUND

Power nailing devices are known in the art. These use compressed air, gas, electrical energy or manual effort to set and drive a series of nails quickly. The nails are delivered from a magazine or other supply such as a coil of parallel nails connected by one or more wires welded to the nail shafts (a “nail strap” or “coil nails”).

When a tool's supply of nails is exhausted, it must be replenished so that work can proceed. Fastener supplies are often heavy and bulky, so it is inconvenient to carry extras around a job site. But returning from a work area to a supply depot to obtain a refill interrupts a workflow and may force workers following the nailer's progress to wait as well. When several workers are “banging nails” on a project, interruptions to reload nail guns may significantly impact the work crew's efficiency.

Furthermore, running a tool completely out of fasteners may result in the worker “dry firing” the tool, which can damage the tool, the material being fastened, or both.

In this environment, a mechanism for alerting the worker that the tool will soon run out of fasteners, and/or that the last fastener in the magazine has been placed, may facilitate the operation of a more-efficient supply chain at the worksite. For example, when a worker's tool is running low on fasteners, an assistant “runner” may be dispatched to retrieve a refill, which can be brought back to the worker timely and loaded into the nail gun with reduced idle time and impact on other workers.

### SUMMARY

In a fastening tool that uses consumable supplies sequentially from a magazine or other store of such fasteners, a visible characteristic of some of the fasteners is manipulated so that the worker using the tool can be informed of the approximate number of fasteners remaining in the tool. The visible characteristic may be a color of the fastener, a shape or another characteristic of the fastener, which is apparent to the user after a fastener is set. In a basic embodiment, the last fastener (or the last few fasteners) delivered from a supply are provided with a different-color surface. For example, the last few nails in a coil-nail strap may have colored heads (i.e., heads that are a different color from nails that are set earlier from the same strap). When the worker observes these visibly-different nails being dispensed, she can prepare for running out of nails by requesting that a refill strap be brought from stores thereof.

### BRIEF DESCRIPTION OF DRAWINGS

FIG. 1 shows the final few nails of a strap of coil nails where an embodiment of the invention is in use.

FIG. 2 shows a different type of fastener, also implementing an embodiment.

FIG. 3 shows yet another type of fastener comprising an embodiment.

FIG. 4 shows another different fastener comprising an embodiment.

FIG. 5 shows another different fastener comprising an embodiment.

### DETAILED DESCRIPTION

Embodiments of the invention alter a standard, prior-art fastener supply for a fastening tool such as a power nailer or stapler in a way that alerts the user of the tool when the number of fasteners remaining in the tool runs low. A straightforward way of accomplishing this alerting function is to alter a visible characteristic of the last fastener (or the last few fasteners) in a refill in a way that is apparent to the user after that fastener (or those fasteners) have been placed.

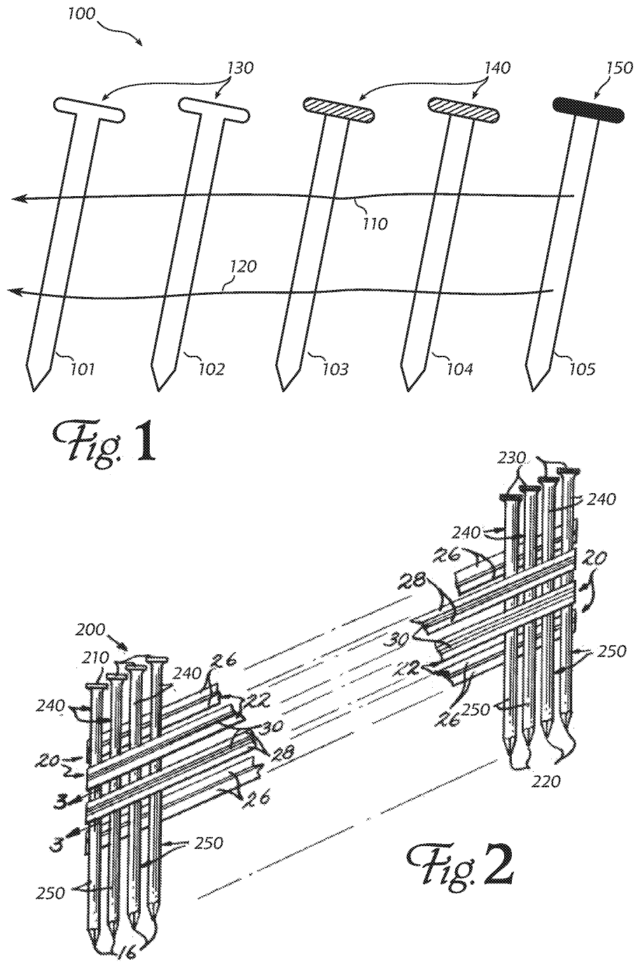

FIG. 1 shows the last few nails in a roll of “coil nails,” or a “nail strap.” Individual nails are held together at a consistent angle and inter-nail spacing by welding wires 110, 120 at suitable places along the shaft of each nail. Coil nails are adapted for use in a power nailer, which unrolls a spool or coil of such nails into the tool's chamber, and then sets each successive nail with a strike that drives the nail, breaking the welds to the wires in the process.

Element 100 shows the last five nails in a coil (101-105). Nails 130 (and all the earlier-dispensed nails in the coil, which would lie to the left of the portion of the coil shown here) have a first visual appearance after driving into a workpiece. This visual appearance is represented by the uncolored nail heads. After nails 130 (and earlier-dispensed nails) are set, nails 140 are set. These have a second visual appearance after driving, indicated by the shaded nail heads. The user of the tool can distinguish nail heads 130 from nail heads 140, and is thus alerted that the nail coil is almost exhausted. The final nail in the coil, 150, has yet a third visual appearance, indicated by the black nail head. After this nail is driven, the tool is empty and the user should not attempt to fire it again.

An embodiment can function with any fastening tool that places fasteners taken sequentially from a store, cache, unit, magazine or other supply of fasteners. A tool that places fasteners taken randomly from a hopper or the like is not suitable. Fasteners implementing an embodiment of the invention must have at least two visually-different appearances within one magazine of functionally-equivalent fasteners, and fasteners dispensed earlier from the magazine should have a first uniform appearance, which changes to the second uniform appearance at a predetermined point in the magazine (i.e., fastener appearance should not change from the first appearance to the second appearance and back to the first appearance within a single magazine).

An embodiment may include two or more different fastener appearances, and the number of fasteners of each different appearance may vary. Preferably, the very last fastener in the magazine will be visually distinguishable from all other fasteners in the magazine, but an embodiment will function acceptably if the last few fasteners (e.g., the last five or ten fasteners) in the magazine are all visually identical.

FIG. 2 shows another embodiment of the invention. At 200, a magazine for an angled nailer is shown. Nails 16 through 220 are held parallel and at a suitable spacing for the tool mechanism by plastic rails 20. This magazine may be inserted into the tool, and nails are set sequentially from left to right. According to an embodiment of the invention, nails 16, which are dispensed first, have a first visual appearance (indicated by clear heads 210); while nails 220, which are dispensed last, have a second visual appearance (indicated by shaded heads 230). Nails in the middle of the magazine (not shown in this Figure) may be similar to the first nails 16, or may have an appearance different from both 16 and 220.

FIG. 3 shows another visually distinguishable fastener characteristic that may be used in an embodiment. In FIGS. 1 & 2, the nail heads were differently colored. (The colors may be paint, stain, electrochemical anodizing, plastic covers, or other means of applying color.) In FIG. 3, the sequence of nails 300 starts with round-headed nails 310, while the very last nail dispensed from the magazine 320 has a square head 330. The actual shape of the nail head is not significant to an embodiment; rather, the important characteristic is that earlier-set nails be visually distinguishable from later-set nails. Nail head shape is another way to accomplish the visual distinction.

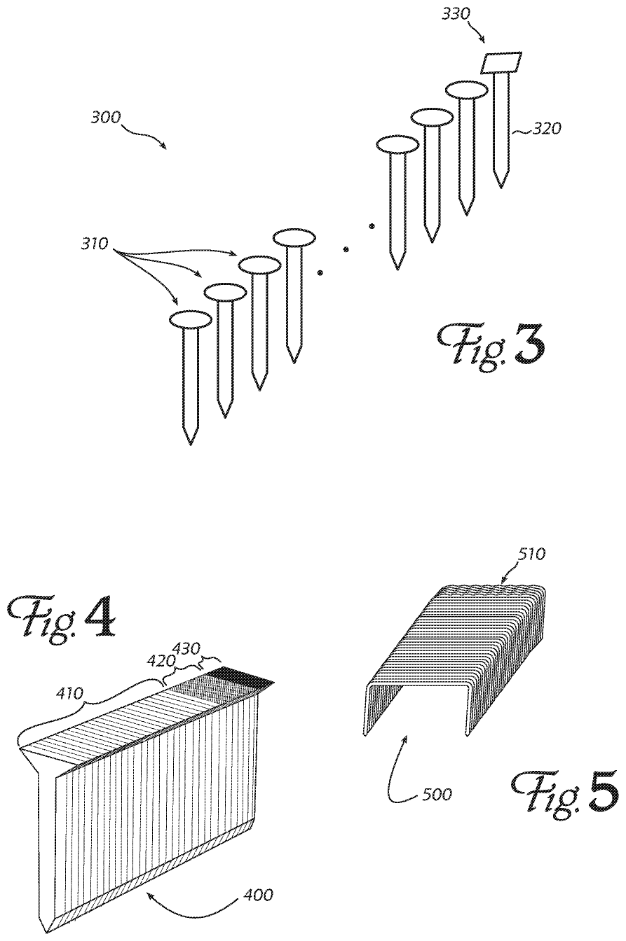

FIG. 4 shows another fastener form where an embodiment can be used. At 400, a strip of flat, square-shaft nails is provided; each nail may be secured to its neighbors by a frangible adhesive or by incomplete severance from a piece of bulk stock. The power nailer's action simultaneously shears each nail apart from the rest of the strip and drives the nail into the workpiece. According to an embodiment, the first group of nails from the strip 410 have a first visual appearance, the second group of nails have a second, different visual appearance, and the final group of nails have a third, different visual appearance. When the user observes black-headed nails being driven, she knows that a refill will be needed soon.

Finally, FIG. 5 shows another different fastener type, commonly known as a staple 500. These fasteners have prongs at each lateral end of a bar; they are typically made by forming two 90° bends on a wire, and they are driven by a thin hammer strike along the back of the staple, which separates the staple from the strip and drives the prongs into the workpiece.

In this embodiment, the last staples to be dispensed from strip 500 (indicated at 510) have a corrugated or wavy back portion, which is visually distinguishable from the smooth backs of earlier-dispensed staples. Again, when the user observes these corrugated-back staples being set, she knows that the stapler is almost empty.

It is appreciated that colored fasteners (and fasteners having similar visually-distinguishable characteristics) are known in the art. For example, U.S. Patent Application Publication No. 2008/0260496 by Parmann describes nails for a pneumatic or electrical power nailer where each nail has a colored head. But Parmann's nails are all the same color—the purpose of the colored head is to assist in visually locating the nail after installation, for example for purposes of inspection. The color may also communicate the nail type or size, so that an inspector can confirm that the proper nail has been used in each location.

Embodiments of the present invention use different colors (or other different, visually-distinguishable characteristics) on fasteners that are otherwise the same. Here, the different visual characteristic communicates useful information to the worker when the fastener is being placed.

The applications of the present invention have been described largely by reference to specific examples and in terms of particular means of achieving visual distinguishability in fasteners such as nails and staples. However, those of skill in the art will recognize that the benefits of an embodiment can also be produced by fastener modifications that are visually distinguishable for other reasons than shape, color or texture. Such variations and implementations are understood to be captured according to the following claims.

We claim:

1. A supply of fasteners for an automatic nailing device, comprising:
a plurality of uniform fasteners secured together so that each fastener of the plurality of fasteners will be delivered in strict sequential order to the automatic nailing device and driven therefrom into a workpiece, wherein
a sequentially last fastener is visibly different after driving from an earlier-driven fastener.

2. The supply of fasteners for an automatic nailing device of claim 1, wherein the sequentially last fastener is visibly different from a sequentially earlier fastener prior to driving into the workpiece.

3. The supply of fasteners for an automatic nailing device of claim 1 wherein the sequentially last fastener is visibly different from the earlier driven fastener by having a different-color head.

4. The supply of fasteners for an automatic nailing device of claim 1 wherein the sequentially last fastener is visibly different from the earlier driven fastener by having a different shape head.

5. The supply of fasteners for an automatic nailing device of claim 1 wherein a final plurality of uniform fasteners delivered in strict sequential order to the automatic nailing device immediately preceding the sequentially last fastener are visually indistinguishable from the sequentially last fastener.

6. The supply of fasteners for an automatic nailing device of claim 5 wherein the final plurality of uniform fasteners is four fasteners.

7. The supply of fasteners for an automatic nailing device of claim 1 wherein an early portion of fasteners delivered in strict sequential order have a uniform early visible appearance after driving, then
a middle portion of fasteners delivered in strict sequential order after the early portion have a uniform middle visible appearance after driving, then
a final portion of fasteners delivered in strict sequential order after the middle portion and before the sequentially last fastener have a uniform final visible appearance after driving.

8. The supply of fasteners for an automatic nailing device of claim 1 wherein the plurality of uniform fasteners is a plurality of nails held together in parallel by at least one wire welded to a shaft of each nail of the plurality of nails.

9. The supply of fasteners for an automatic nailing device of claim 1 wherein the plurality of uniform fasteners is a plurality of nails held together in parallel by a feeder strip.

10. The supply of fasteners for an automatic nailing device of claim 1 wherein the plurality of uniform fasteners is a plurality of nails partially formed but incompletely separated from one another in a strip.

11. A roll of coil nails for an automatic nail gun, comprising:
a first sequence of nails in a coil having a head of a first color; and
at least one nail in the coil having a head of a final, different color, wherein
the at least one nail is a last nail to be driven from the roll of coil nails.

12. The roll of coil nails of claim 11 wherein the at least one nail is n nails, each of said n nails having a head of the final color, and the n nails being the last n nails to be driven from the roll of coil nails, where n is an integer.

13. The roll of coil nails of claim 12 wherein n is between two (2) and ten (10).

14. The roll of coil nails of claim 12 wherein n is five (5).

15. The roll of coil nails of claim 11, further comprising:
a second sequence of nails in the coil having a head of a second color, all of the nails of said second sequence lying after all of the nails of said first sequence and before the at least one nail,
the second color being visibly different from the first color and the final, different color.

16. A roll of coil nails for an automatic nail gun, comprising:
a first sequence of nails in a coil having a head of a first shape; and
at least one nail in the coil having a head of a final, different shape, wherein
the at least one nail is a last nail to be driven from the roll of coil nails.

17. The roll of coil nails of claim 16 wherein the at least one nail is n nails, each of said n nails having a head of the final shape, and the n nails being the last n nails to be driven from the roll of coil nails, where n is an integer.

18. The roll of coil nails of claim 17 wherein n is between two (2) and ten (10).

19. The roll of coil nails of claim 17 wherein n is five (5).

20. The roll of coil nails of claim 16, further comprising:
a second sequence of nails in the coil having a head of a second shape, all of the nails of said second sequence lying after all of the nails of said first sequence and before the at least one nail,
the second shape being visibly different from the first shape and the final, different shape.
